(19) United States
(12) Patent Application Publication
(10) Pub. No.: US 2019/0034282 A1
(43) Pub. Date: Jan. 31, 2019

(54) OFFLINE REPOPULATION OF CACHE

(71) Applicant: EMC IP Holding Company LLC, Hopkinton, MA (US)

(72) Inventors: Rahul B. Ugale, Santa Clara, CA (US); Satish Kumar Kashi Visvanathan, San Jose, CA (US); Mahesh Kamat, San Jose, CA (US)

(21) Appl. No.: 15/663,434

(22) Filed: Jul. 28, 2017

(51) Int. Cl. G06F 11/14; G06F 12/0831; G06F 12/0866; G06F 12/128; G06F 12/14

(52) U.S. Cl. CPC G06F 11/1441; G06F 12/0833; G06F 12/0802; G06F 12/128; G06F 12/14; G06F 12/0866

(57) ABSTRACT

A data storage device includes a cache for an object storage and a processor. The processor suspends processing of files for storage in the object storage. While the processing of files is suspended the processor generates a rebuilt index using the object storage, generates a rebuilt index cache using the object storage, stores the rebuilt index in the object storage, and stores the rebuilt index cache in the cache.

### BACKGROUND

Computing devices generate, use, and store data. The data may be, for example, images, document, webpages, or meta-data associated with any of the files. The data may be stored locally on a persistent storage of a computing device and/or may be stored remotely on a persistent storage of another computing device.

### SUMMARY

In one aspect, a data storage device in accordance with one or more embodiments of the invention includes a cache for an object storage and a processor. The processor suspends processing of files for storage in the object storage. While the processing of files is suspended the processor generates a rebuilt index using the object storage, generates a rebuilt index cache using the object storage, stores the rebuilt index in the object storage, and stores the rebuilt index cache in the cache.

In one aspect, a method of operating a data storage device in accordance with one or more embodiments of the invention includes suspending, by the data storage device, processing of files for storage in an object storage. The method further includes while the processing of files is suspended, generating, by the data storage device, a rebuilt index using the object storage and a rebuilt index cache using the object storage; storing, by the data storage device, the rebuilt index in the object storage; and storing, by the data storage device, the rebuilt index cache in a cache for the object storage.

In one aspect, a non-transitory computer readable medium in accordance with one or more embodiments of the invention includes computer readable program code, which when executed by a computer processor enables the computer processor to perform a method for operating a data storage device, the method includes suspending, by the data storage device, processing of files for storage in an object storage. The method further includes while the processing of files is suspended, generating, by the data storage device, a rebuilt index using the object storage and a rebuilt index cache using the object storage; storing, by the data storage device, the rebuilt index in the object storage; and storing, by the data storage device, the rebuilt index cache in a cache for the object storage.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments of the invention.

FIG. 1B shows a diagram of an index in accordance with one or more embodiments of the invention.

FIG. 1C shows a diagram of an index cache in accordance with one or more embodiments of the invention.

FIG. 1D shows a diagram of an object storage in accordance with one or more embodiments of the invention.

FIG. 1E shows a diagram of an object of an object storage in accordance with one or more embodiments of the invention.

FIG. 1F shows a diagram of a mapping in accordance with one or more embodiments of the invention.

FIG. 1G shows a diagram of an entry of a mapping in accordance with one or more embodiments of the invention.

FIG. 2A shows a diagram of a file in accordance with one or more embodiments of the invention.

FIG. 2B shows a diagram of a relationship between segments of a file and the file in accordance with one or more embodiments of the invention.

FIG. 3 shows a flowchart of a method of operating a data storage device in accordance with one or more embodiments of the invention.

FIG. 4 shows a flowchart of a method of rebuilding an index and an index cache in accordance with one or more embodiments of the invention.

FIG. 5 shows a flowchart of a method of generating an index and an index cache in accordance with one or more embodiments of the invention.

FIG. 6A shows a diagram of a first example object storage.

FIG. 6B shows a diagram of a first example index.

FIG. 6C shows a diagram of a first example index cache.

FIG. 7A shows a diagram of a second example object storage.

FIG. 7B shows a diagram of a second example index.

FIG. 7C shows a diagram of a second example index cache.

FIG. 8A shows a diagram of a third example object storage.

FIG. 8B shows a diagram of a third example index.

FIG. 8C shows a diagram of a third example index cache.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for storing data. More specifically, the systems, devices, and methods may reduce the amount of storage required to store data.

In one or more embodiments of the invention, a data storage device may deduplicate data before storing the data in a data storage. The data storage device may deduplicate the data against data already stored in the data storage before storing the deduplicated data in the data storage.

For example, when multiple versions of a large text document having only minimal differences between each of the versions are stored in the data storage, storing each version will require approximately the same amount of storage space if not deduplicated. In contrast, when the multiple versions of the large text document are deduplicated before storage, only the first version of the multiple versions stored will require a substantial amount of storage. Segments that are unique to both versions of the word document will be retained in the storage while duplicate segments included in subsequently stored version of the large text document will not be stored.

To deduplicate data, a file of the data may be broken down into segments. Fingerprints of the segments of the file may be generated. As used herein, a fingerprint may be a bit sequence that virtually uniquely identifies a segment. As used herein, virtually uniquely means that the probability of collision between each fingerprint of two segments that include different data is negligible, compared to the probability of other unavoidable causes of fatal errors. In one or more embodiments of the invention, the probability is 10⁻²⁰ or less. In one or more embodiments of the invention, the unavoidable fatal error may be caused by a force of nature such as, for example, a tornado. In other words, the fingerprint of any two segments that specify different data will virtually always be different.

In one or more embodiments of the invention, the fingerprints of the segments are generated using Rabin's fingerprinting algorithm. In one or more embodiments of the invention, the fingerprints of the unprocessed file segment are generated using a cryptographic hash function. The cryptographic hash function may be, for example, a message digest (MD) algorithm or a secure hash algorithm (SHA). The message MD algorithm may be MD5, The SHA may be SHA-Q, SHA-1, SHA-2, or SHA3. Other fingerprinting algorithms may be used without departing from the invention.

To determine whether any of the segments of the file are duplicates of segments already stored in the data storage, the fingerprints of the segments of the file may be compared to the fingerprints, stored in an index in the data storage, of segments already stored in the data storage. Any segments of the file having fingerprints that match fingerprints of segments stored in the index of the data storage may be marked as duplicate and not stored in the data storage. The fingerprints of the stored segments may be added to the index. Not storing the duplicate segments in the data storage may reduce the quantity of storage required to store the file when compared to the quantity of storage space required to store the file without deduplicating the segments of the files.

In one or more embodiments of the invention, the data storage device may include a cache that mirrors all of the fingerprints, or a portion thereof, in the data storage. The cache maybe hosted by one or more physical storage devices that are higher performance than the physical stored devices hosting the data storage. The cache may be to supply the fingerprints as part of the deduplication process rather than the index stored in the data storage. In one or more embodiments of the invention, the cache may be hosted by solid state drives and the data storage may be hosted by one or more hard disk drives.

In one or more embodiments of the invention, the data storage device may rebuild the cache in response to an event that modifies the structure of the index. In one or more embodiments of the invention, the event may be a corruption of one or more fingerprints of the segments stored in the index of the data storage. In one or more embodiments of the invention, the event may be a change in the structure of the index of the data storage. For example, as new storage is added to the data storage the index may be increased in size to match the larger number of segments that may be stored in the index. The event may be other types of events that modify the structure of the index of the data storage without departing from the invention.

In one or more embodiments of the invention, the cache may be rebuilt by generating an index cache that mirrors the index on the data storage. The index may mirror all or a portion of the segments stored in the index. The cache may be rebuilt in an offline state, i.e., when the data storage device is unavailable to store data. Rebuilding the cache based on the entries of the index, rather than based on cache misses, may improve the operation of the data storage device by prevent cache misses.

Populating the cache based on cache misses, i.e., populating the cache with information requested that is unavailable from the cache at the time of the request but is available from the data storage at the time of the request, may reduce the performance of the data storage device following a rebuild of the cache until the cache is populated. The period of time following the rebuild of the cache based on cache misses may be substantially longer than the period of time it takes to rebuild the cache based on the index of the data storage.

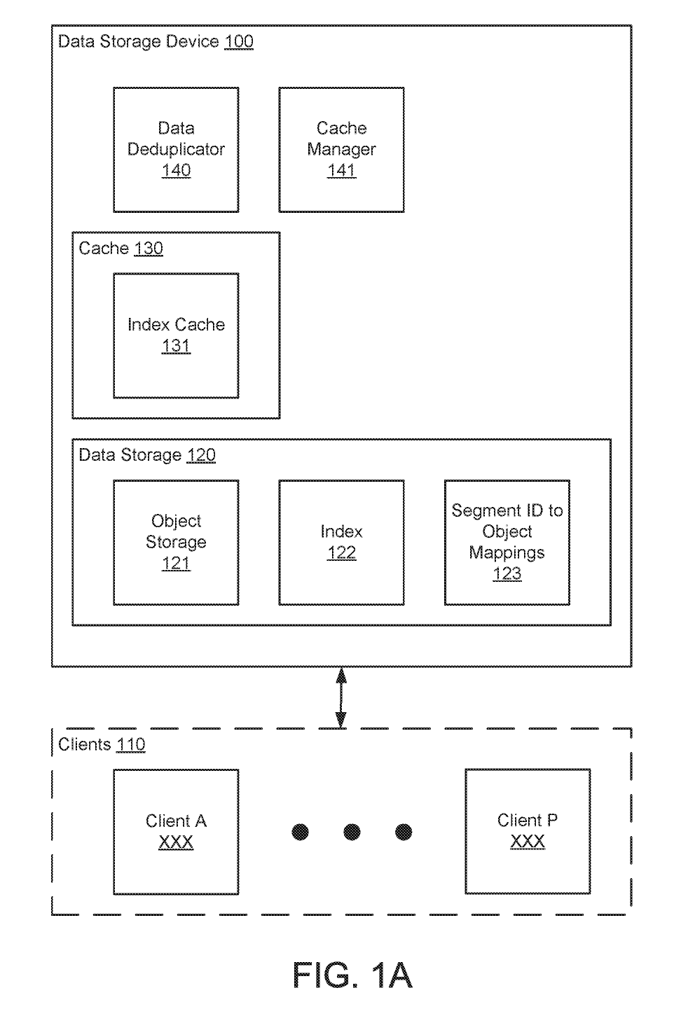

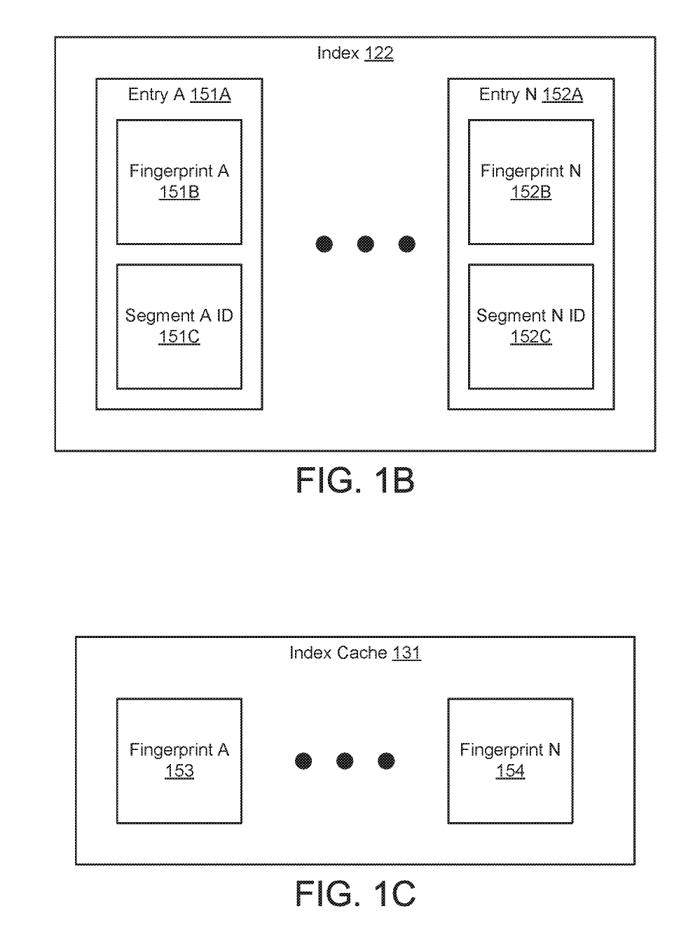

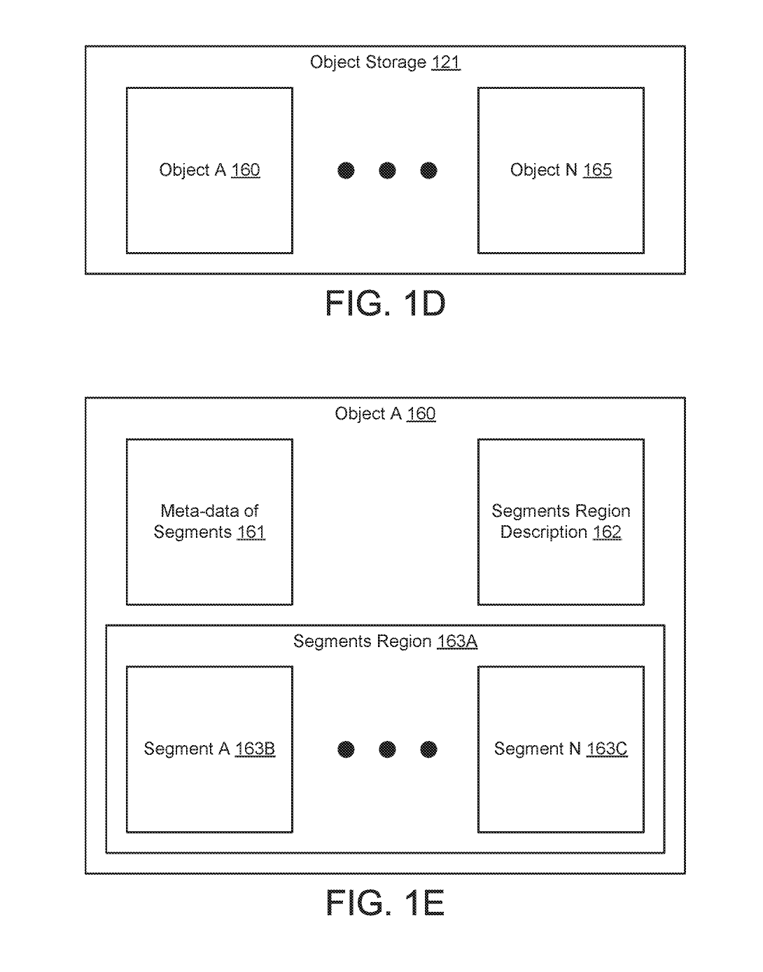

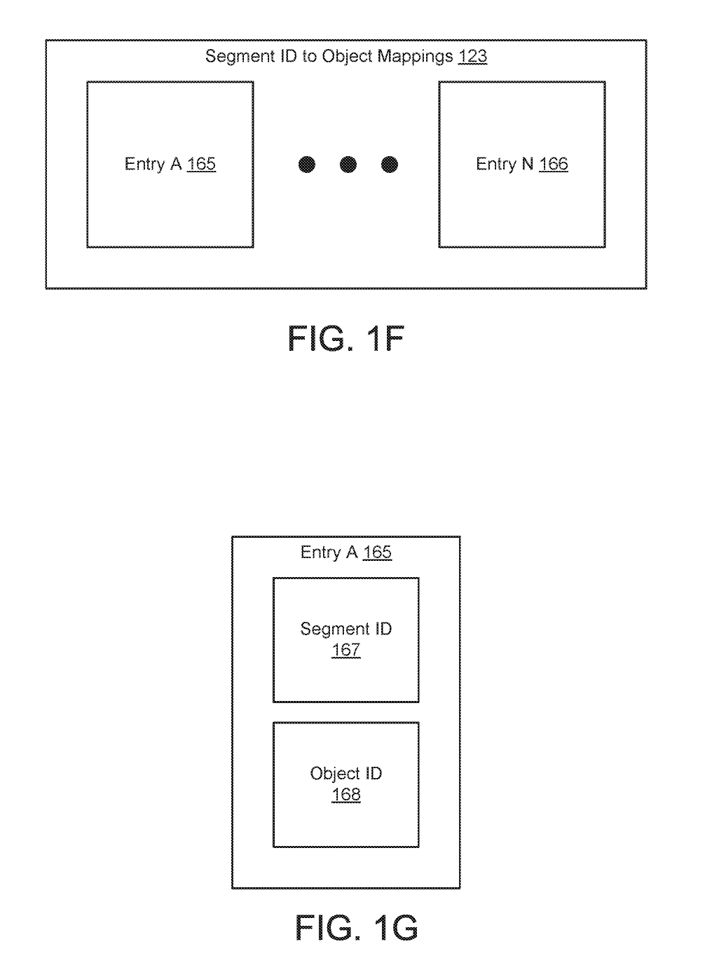

FIG. 1A shows a system in accordance with one or more embodiments of the invention. The system may include clients (110) that store data in the data storage device (100).

The clients (110) may be computing devices. The computing devices may be, for example, mobile phones, tablet computers, laptop computers, desktop computers, or servers. The computing devices may include one or more processors, memory (e.g., random access memory), and persistent storage (e.g., disk chives, solid state drives, etc.). The persistent storage may store computer instructions, e.g., computer code, that when executed by the processor(s) of the computing device cause the computing device to perform the functions described in this application. The clients (110) may be other types of computing devices without departing from the invention. The clients (110) may be operably connected to the data storage device (100) via a network.

The clients (110) may store data in the data storage device (100). The data may be of any time or quantity. The clients (110) may store the data in the data storage device (100) by sending data storage requests to the data storage device (100) via an operable connection. The data storage request may specify one or more names that identify the data to-be-stored by the data storage device (100) and include the data. The names that identify the data to-be-stored may be later used by the clients (110) to retrieve the data from the data storage device (100) by sending data access requests including the identifiers included in the data storage request that caused the data to be stored in the data storage device (100).

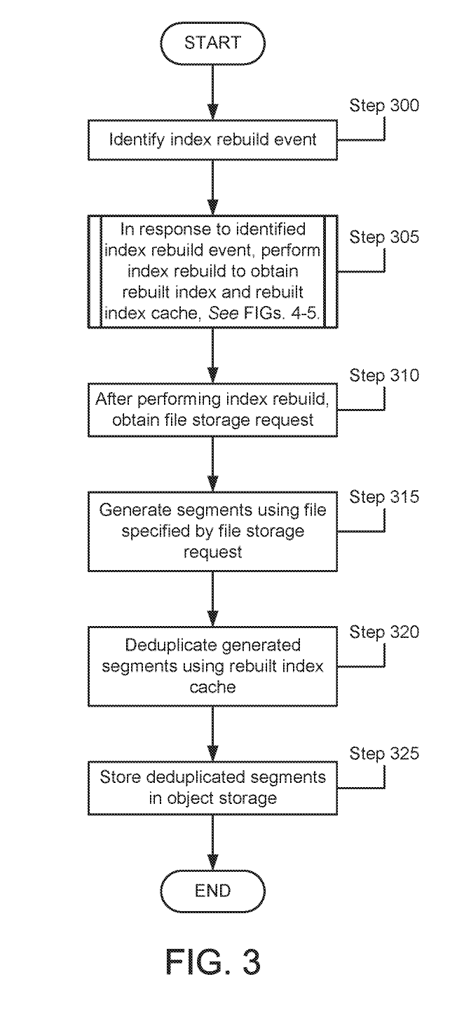

The data storage device (100) may be a computing device. The computing device may be, for example, a mobile phone, a tablet computer, a laptop computer, a desktop computer, a server, or a cloud resource. As used herein, a cloud resource means a logical computing resource that utilizes the physical computing resources of multiple computing devices, e.g., a cloud service. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions described in this application and illustrated in at least FIGS. 3-7. The data storage device (100) may be other types of computing devices without departing from the invention.

The data storage device (100) may store data sent to the data storage device (100) from the clients (110) and provide data stored in the data storage device (100) to the clients (110). The data storage device (100) may include a data storage (120) that stores the data from the clients, a cache (130), a data deduplicator (140), and a cache manager (141). Each component of the data storage device (100) is discussed below.

The data storage device (100) may include a data storage (120). The data storage (120) may be hosted by a persistent storage that includes physical storage devices. The physical storage devices may be, for example, hard disk drives, solid state drives, hybrid disk drives, tape drives that support random access, or any other type of persistent storage media. The data storage (120) may include any number and/or combination of physical storage devices.

The data storage (120) may include an object storage (121) for storing data from the clients (110). As used herein, an object storage is a data storage architecture that manages data as objects. Each object may include a number of bytes for storing data in the object. In one or more embodiments of the invention, the object storage does not include a file system. Rather, a namespace (not shown) may be used to organize the data stored in the object storage. The namespace may associate names of files stored in the object storage with identifiers of segments of files stored in the object storage. The namespace may be stored in the data storage. For additional details regarding the object storage (121), see FIGS. 1D-1E.

The object storage (121) may be a partially deduplicated storage. As used herein, a partially deduplicated storage refers to a storage that attempts to reduce the required amount of storage space to store data by not storing multiple copies of the same files or bit patterns. A partially deduplicates storage attempts to balance the input-output (10) limits of the physical devices on which the object storage is stored by only comparing the to-be-stored data to a portion of all of the data stored in the object storage.

To partially deduplicate data, the to-be-stored data may be broken down into segments. The segments may correspond to portions of the to-be-stored data. Fingerprints that identify each segment of the to-be-stored data may be generated. The generated fingerprints may be compared to the fingerprints of a portion of the segments stored in the object storage. In other words, the fingerprints of the to-be-stored data may only be deduplicated against the fingerprints of a portion of the segments in the object storage and is not deduplicated against the fingerprints of all of the segments in the object storage. Any segments of the to-be-stored data that do not match a fingerprint of the portion of the segments stored in the object storage may be stored in the object storage, the other segments may not be stored in the object storage. A recipe to generate the now-stored data may be generated and stored in the data storage so that the now-stored data may be retrieved from the object storage. The recipe may enable all of the segments required to generate the now-stored data to be retrieved from the object storage. Retrieving the aforementioned segments may enable the file to be regenerated. The retrieved segments may include segments that were generated when segmenting the data and segments that were generated when segmenting other data that was stored in the object storage prior to storing the now-stored segments.

In one or more embodiments of the invention, the namespace may be a data structure stored on physical storage devices of the data storage (120) that organizes the data storage resources of the physical storage devices. In one or more embodiments of the invention, the namespace may associate a file with a file recipe stored in the object storage. The file recipe may be used to generate the file based using segments stored in the object storage.

The data storage device (100) may include an index (122′. The index may be a data structure that includes fingerprints of each segment stored in the object storage and associates each of the fingerprints with an identifier of a segment from which the respective fingerprint was generated. For additional details regarding the index (122), See FIG. 1B.

The data storage device (100) may include segment identifiers (ID) to object mappings (123). The mappings may associate an II) of a segment with an object of the object storage that includes the segment identified by the segment ID. The aforementioned mappings may be used to retrieve segments from the object storage.

More specifically, when a data access request is received, it may include a file name. The file name may be used to query the namespace to identify a file recipe. The file recipe may be used to identify the identifiers of segments required to generated the file identified by the file name. The segment ID to object mappings may enable objects of the object storage that include the segment identified by the segment IDs of the file recipe to be identified. As will be discussed below, each object of the object may be self-describing and, thereby, enable the segments to be retrieved from the objects once the objects that include the segments are identified. For additional details regarding the segment identifiers ID to object mappings (123), See FIGS. 1F and 1G.

As discussed above, the data storage device (100) may include a cache (130). The cache (130) may be hosted by a persistent storage that includes physical storage devices. The physical storage devices may be, for example, hard disk drives, solid state drives, hybrid disk drives, or any other type of persistent storage media. The physical storage devices of the cache (130) may have better performance characteristics than the physical storage devices of the data storage (120). For example, the physical storage devices of the cache may support higher input-output (10) rates than the physical storage devices off the data storage. In one or more embodiments of the invention, the physical storage devices hosting the cache may be a number of solid state drives and the physical storage hosting the data storage may be hard disk drives. The cache (130) may include any number and/or combination of physical storage devices.

The cache (130) may include an index cache (131). The index cache (131) may be a cache for the fingerprints of the index (122). More specifically, the index cache (131) maybe a data structure that includes a portion of the fingerprints of the index (122). When deduplicating data, the data storage device may first attempt to retrieve fingerprints from the index cache (131). If the fingerprints are not in the cache, the data storage device may retrieve the fingerprints from the index (122) of the data storage (120).

In one or more embodiments of the invention, the index cache (131) mirrors all of the fingerprints, or a portion thereof, of the index (122). In one or more embodiments of the invention, when only mirroring a portion of the fingerprints, the fingerprints stored in the index cache (131) may be based on a relative frequency of request of the fingerprints. In other words, the portion of the fingerprints of the index that are mirrored by the index cache (131) may be selected based on cache misses.

In one or more embodiments of the invention, the index cache (131) may be rebuilt in response to an event. The rebuilt index cache (131) may include the same, or different, fingerprints than were stored in the index cache (1.31) prior to being rebuilt. In one or more embodiments of the invention, the fingerprints stored in the rebuilt index cache (131) may be selected based on the fingerprints stored in the index (122) rather than based on cache misses. For additional details regarding the index cache (131), See FIG. 1C.

The cache (132) may also include a cache hardware heuristics (132). The cache hardware heuristics (132) may include data regarding the usage of the physical storage devices hosting the cache (130). The cache hardware heuristics (132) may also include a goal for the usage of the physical storage devices hosting the cache (130).

The data storage device (100) may include a data deduplicator (140). The data deduplicator (140) may partially deduplicate segments of files before the segments are stored in the object storage (121). As discussed above, the segments may be partially deduplicated by comparing fingerprints of the segments of the to-be-stored file to a portions of the fingerprints stored in the index cache (130 and/or the index (122). In other words, the data deduplicator (140) may generate partially deduplicated segments, i.e., segments that have been deduplicated against a portion of the data stored in the object storage. Thus, the partially deduplicated segments still may include segments that are duplicates of segments stored in the object storage (121.)

In one or more embodiments of the invention, the data deduplicator (140) may be a physical device. The physical device may include circuitry. The physical device may be, for example, a field-programmable gate array, application specific integrated circuit, programmable processor, microcontroller, digital signal processor, or other hardware processor. The physical device may be adapted to provide the functionality described throughout this application.

In one or more embodiments of the invention, the data deduplicator (140) may be implemented as computer instructions, e.g., computer code, stored on a persistent storage that when executed by a processor of the data storage device (100) cause the data storage device (100) to provide the functionality described throughout this application.

When deduplicating segments, the data deduplicator (140) compares the fingerprints of segments of to-be-stored files to the fingerprints of segments in the object storage (121). To improve the rate of the deduplication, the index cache (130 may be used to provide the fingerprints of the segments in the object storage (121) rather than the index (122).

The data storage device (100) may include a cache manager (141) that manages the contents of the index cache (131). More specifically, the cache manager (141) may mirror fingerprints of the index (122) in the index cache (131) and may rebuild the index cache (131) in response to an event. The cache manager (141) may rebuild the cache index (131) while the data storage device is offline, i.e., not storing data from clients.

In one or more embodiments of the invention, the each manager (141) may be a physical device. The physical device may include circuitry. The physical device may be, for example, a field-programmable gate array, application specific integrated circuit, programmable processor, microcontroller, digital signal processor, or other hardware processor. The physical device may be adapted to provide the functionality described throughout this application and the methods illustrated in FIGS. 3-5.

In one or more embodiments of the invention, the cache manager (141) may be implemented as computer instructions, e.g., computer code, stored on a persistent storage that when executed by a processor of the data storage device (100) cause the data storage device (100) to provide the functionality described throughout this application and the methods illustrated in FIGS. 3-5.

As discussed above, the index (122) and index cache (131) may be used to supply fingerprints to the data deduplicator (140) when segments of files are being deduplicated.

FIG. 1B shows a diagram of an index (122) in accordance with one or more embodiments of the invention. The index (122) includes entries (151A, 152A). Each of the entries may include a fingerprint (151B, 152B) and a segment II) (151C, 152C) of a segment used to generate the fingerprint of the entry.

FIG. 1C shows a diagram of an index cache (131) in accordance with one or more embodiments of the invention. The index cache (131) includes a number of fingerprints (153, 154). The fingerprints (153, 154) of the index cache (131) may be selected/stored in the index cache (131) by the cache manager via the methods illustrated in FIGS. 3-5.

The index (122) and index cache (131) may include fingerprints of segments stored in the object storage (121, FIG. 1A). As noted above, the index cache (131) may include fewer fingerprints (153, 154) than the fingerprints (151B, 152B, FIG. 1B) stored by the index (122, FIG. 1B).

The fingerprints of the index and index cache may be associated with segments of files stored in an object storage (121, FIG. 1A).

FIG. 1D shows a diagram of an object storage (121) in accordance with one or more embodiments of the invention. The object storage (121) include a number of objects (160, 165). Each of the objects may store a number of segments and meta-data regarding the segments stored in respective objects of the object storage (121).

FIG. 1E shows a diagram of an example of an object A (160) in accordance with one or more embodiments of the invention. Object A (160) includes meta-data of the segments (161) stored in object A (160) and a segments region description (162) that specifies a layout of a segments region (163A). The segments region (163A) includes a number of segments (163B, 163C). The segments region description (162) and meta-data of the segments (161) include information that enables object A (160) to be self descriptive, i.e., so that the segments (163B, 163C) can be read from the object using only the contents of the object without referencing other data structures.

The segments region description (162) may specify, for example, the start point of the segments region (163A) from the start of object A (160), the length of each segment (163B, 163C), and/or the end point of the segments region (163A.). The segments region description (163) may include other/different data that enables the object to be self-describing without departing from the invention.

The meta-data of segments (161) may include, for example, the fingerprint of each segment and/or the size of each segment in the segments region (163A). The mea-data of segments (161) may include other/different data without departing from the invention.

Returning to FIG. 1A, the data storage device may read a file stored in the object storage (121) by obtaining segments from the object storage (121) and generating the file using the obtained segments. The obtained files may be specified by a file recipe associated with the file stored in the object storage (121). To obtain the segments from the object storage (121), the data storage device (100) may identify objects of the object storage (121) that include each of the specified files using segment ID to object mappings (123).

FIG. 1F shows a diagram of segment II) to object mappings (123). The segment ID to object mappings (123) include a number of entries (165, 166) that each associate a segment ID with an object ID.

FIG. 1G shows an example of an entry A (165) of the segment ID to object mappings (123). Entry A (165) includes a segment ID (167) and an object ID (168). Thus, each entry relates an identifier of a segment to an identifier of an object that includes the segment identified by the segment ID (167). The aforementioned mappings may be used to retrieve segments from the object storage. As discussed above, each object of the object storage may be self-describing and thereby enable a desired segment to be retrieved from the object once the object that includes the desired segment is identified.

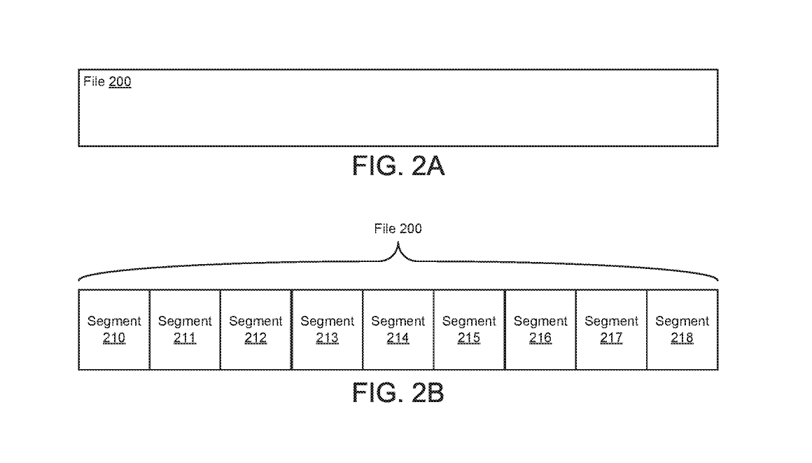

Returning to FIG. 1A, the cache manager (141) may modify the contents of the cache index as file are deduplicated and may rebuild the index cache. When a file is sent to the data storage device for storage, the data management device may divide the file into segments. FIGS. 2A-2B show diagrams that illustrate relationships between a file (200) and segments (210-218) of the file (200).

FIG. 2A shows a diagram of a file (200) in accordance with one or more embodiments of the invention. The data may be any type of data in any format and of any length.

FIG. 2B shows a diagram of segments (210-218) of the file (200) of the data. Each segment may include separate, distinct portions of the file (200). Each of the segments may be of different, but similar lengths. For example, each segment may include approximately 8 kilobytes of data, e.g., a first segment may include 8.03 kilobytes of data, the second segment may include 7.96 kilobytes of data, etc. In one or more embodiments of the invention, the average amount of data of each segment is between 7.95 and 8.05 kilobytes.

FIGS. 3-5 show flowcharts in accordance with one or more embodiments of the invention. The flowcharts illustrate methods that may be used to store data in an object storage using a cache managed by a cache manager. As discussed above, the cache may be regenerated following an event.

FIG. 3 shows a flowchart of a method in accordance with one or more embodiments of the invention. The method depicted in FIG. 3 may be used to store data in an object storage in accordance with one or more embodiments of the invention. The method shown in FIG. 3A may be performed by, for example, a data storage device (100, FIG. 1A).

In Step 300, an index rebuild event is identified. The index rebuild event may be, for example, a corruption of a portion of an index. The index rebuild event may be other types of event without departing from the invention.

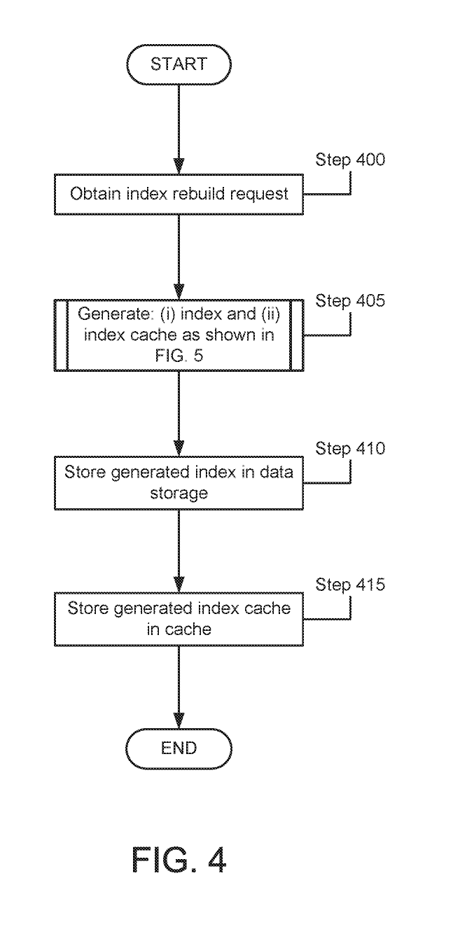

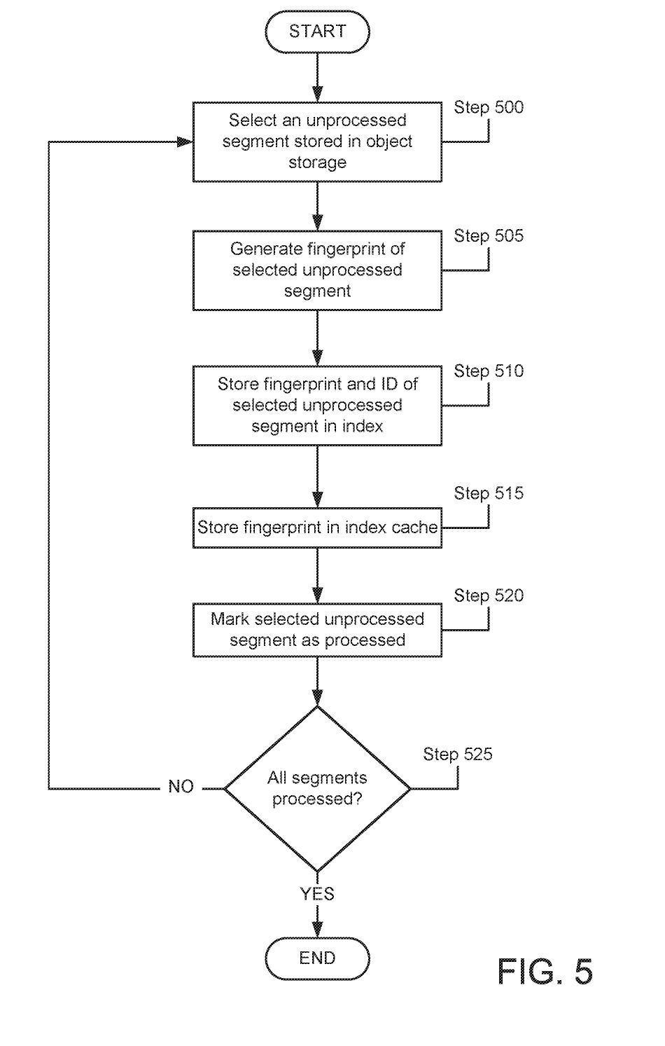

In Step 305, an index rebuild is performed to obtain a rebuilt index and a rebuilt index cache in response to the index rebuild event. The index rebuild may be performed using the method shown in FIGS. 4-5. The index rebuild may be performed using other methods than those shown in FIGS. 4-5 without departing from the invention.

In one or more embodiments of the invention, Step 305 maybe performed by the data storage device in an offline state. As used herein, an offline state means a state where the data storage device is not storing data from clients.

In Step 310, a file storage request is obtained from a client. The file storage request may specify a file for storage in the data storage device.

In Step 315, the file is segmented to obtain segments of the file.

In Step 320, the segments are deduplicated using the rebuilt index cache. More specifically, at least one fingerprint of the segments is matched to a fingerprint stored in the rebuilt index cache. The segment having the at least one fingerprint is deleted. The remaining segments are the deduplicated segments.

In Step 325, the deduplicated segments are stored in the object storage.

The method may end following Step 325.

FIG. 4 shows a flowchart of a method in accordance with one or more embodiments of the invention. The method depicted in FIG. 4 may be used to perform an index rebuild in accordance with one or more embodiments of the invention. The method shown in FIG. 4 may be performed by, for example, a cache manager (141, FIG. 1A).

In Step 400, an index rebuild request is obtained. The index rebuild request may be obtained from an index manager of the object storage. The index rebuild request may be sent in response to identification of an index rebuild event.

In Step 405, an index and an index cache are generated. The index and an index cache may be generated using the method shown in FIG. 5. The index and an index cache may be generated using other method without departing from the invention.

In one or more embodiments of the invention, the index and index cache may be rebuilt based on the segments stored in the object storage.

In Step 410, the generated index is stored in the data storage.

In Step 415, the generated index cache is stored in the cache.

The method may end following Step 415.

FIG. 5 shows a flowchart of a method in accordance with one or more embodiments of the invention. The method depicted in FIG. 5 may be used to generate an index and/or an index ache in accordance with one or more embodiments of the invention. The method shown in FIG. 5 may be performed by, for example, a cache manager (141, FIG. 1A).

In Step 500, an unprocessed segment stored in the object storage is selected. At the beginning of the method illustrated in FIG. 5, all of the segments stored in the object storage may be considered unprocessed, the index cache may be emptied, and the index may be emptied.

In Step 505, a finger print of the selected unprocessed segment is generated. The fingerprint may be generated by obtaining a hash of the selected unprocessed segment. In one or more embodiments of the invention, the hash may be a cryptographic hash. In one or more embodiments of the invention, the cryptographic has may be a secure hash algorithm 1 (SHA-1), a secure hash algorithm 2 (SHA-2), or a secure hash algorithm 3 (SHA-3).

In Step 510, the generated fingerprint and an identifier of the selected unprocessed segment are stored in the index of the data storage.

In Step 515, the generated fingerprint is stored in the index cache.

In one or more embodiments of the invention, the generated fingerprint may be deduplicated against the fingerprints stored in the index cache before the generated fingerprint is stored in the index cache. In other words, the generated fingerprint may be compared to the fingerprints in the index cache. If the generated fingerprint is not a duplicate, it may be stored in the index cache. If the generated fingerprint is a duplicate, it may be deleted rather than stored in the index cache.

In one or more embodiments of the invention, an age of the selected unprocessed segment may be compared against a predetermined storage age before the generated fingerprint is stored in the index cache. If the storage age of the selected unprocessed segment is greater than the predetermined storage age, e.g., older than the predetermined age, the generated fingerprint may be deleted rather than stored in the index cache.

In one or more embodiments of the invention, the predetermined storage age may be 6 months. In one or more embodiments of the invention, the predetermined storage age may be between 1 month and 18 months. In one or more embodiments of the invention, the predetermined storage age may be 12 months.

In or more embodiments of the invention, an identifier of an object that stores the selected unprocessed segment may be used as the storage age of the selected unprocessed segment. In one or more embodiments of the invention, as segments are stored in objects, the objects may be given numerical identifiers that monotonically increase in value. Thus, objects having a larger ID store segments having a younger storage age while objects having a smaller ID store segments have an older storage age.

In one or more embodiments of the invention, the predetermined storage age may be selected so that a predetermined percentage of all of the segments in the object storage may be considered to be older than the predetermined storage age. In one or more embodiments of the invention, the predetermined percentage may be between 10% and 30%. In one or more embodiments of the invention, the predetermined percentage may be 25%.

In one or more embodiments of the invention, the objects of the object storage may be enumerated, starting at the object having the lowest object identifier, in numerically increasing value until the object having the predetermined storage age is identifier. All of the segments of the enumerated objects may be marked as processed at the start of the method shown in FIG. 5. Doing so may improve the uptime of the data storage device by reducing the amount of time required to rebuild the index and index storage.

In Step 520, the selected unprocessed segment is marked as processed.

In Step 525, it is determined whether all of the segments of the object storage have been processed. If all of the segments have been processed, the method may end following Step 525. If all of the segments have not been processed, the method may proceed to Step 500 following Step 525.

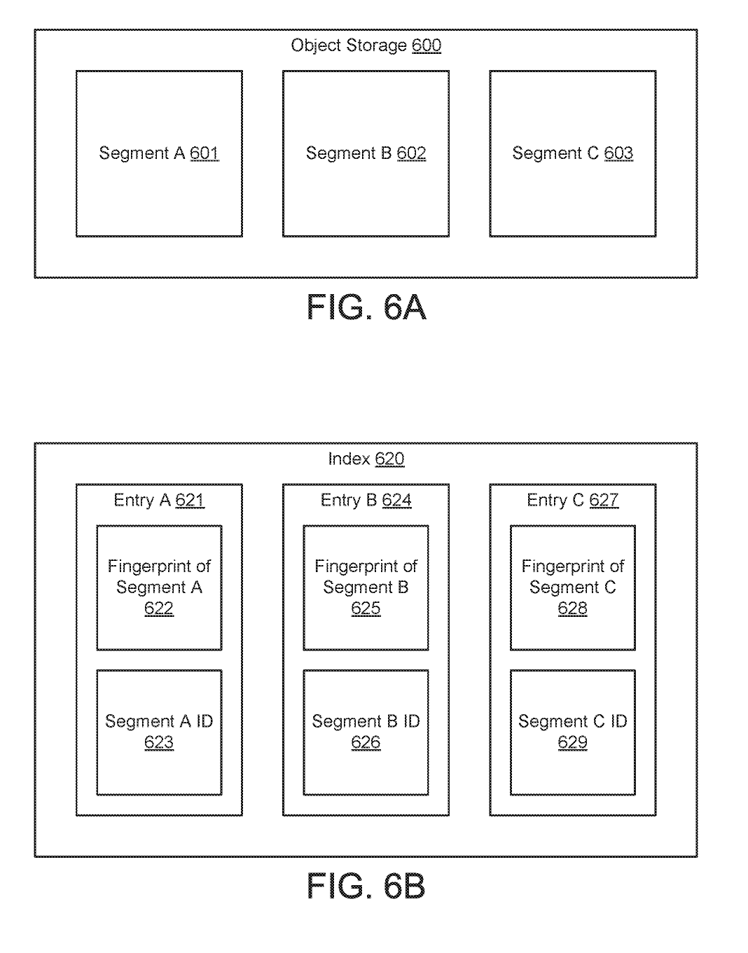

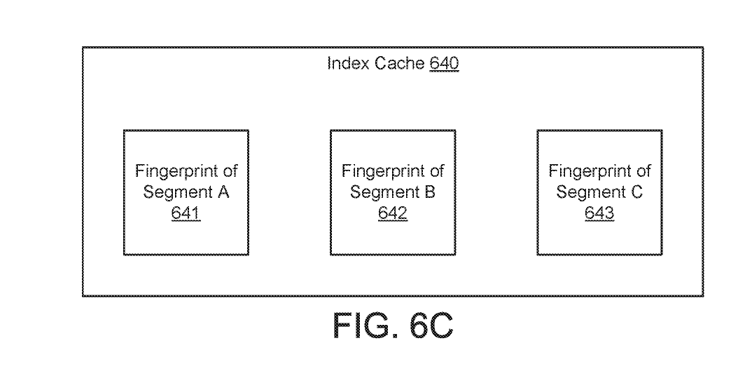

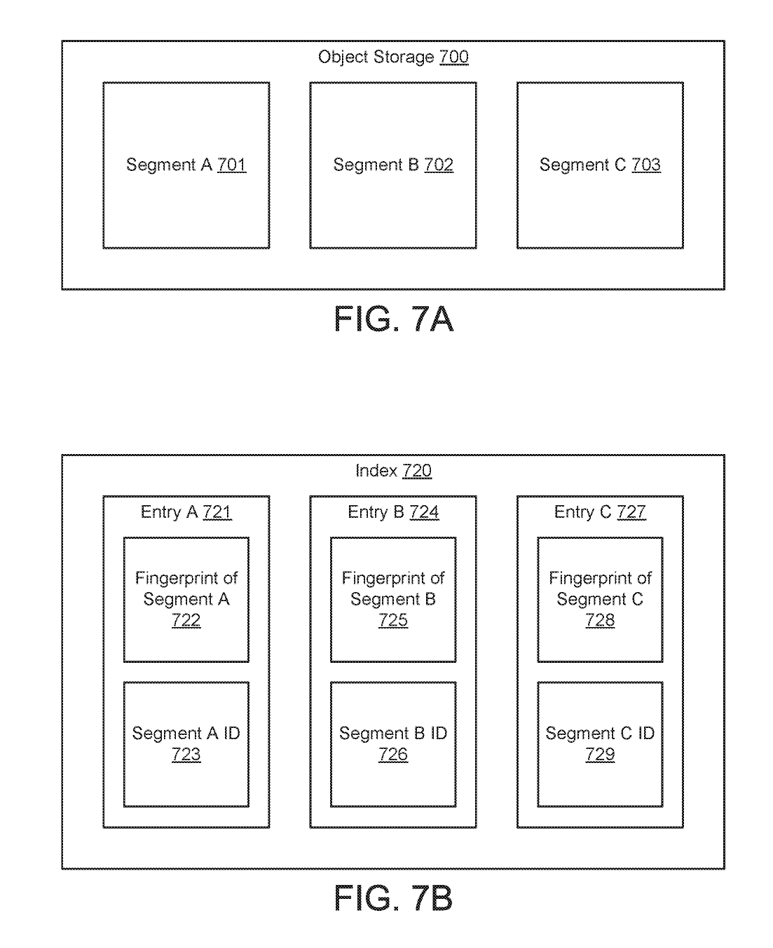

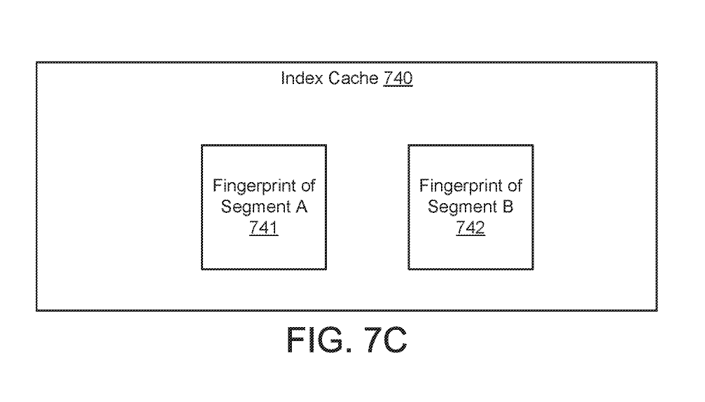

To further clarify embodiments of the invention, FIGS. 6A-7C shows diagrams an examples. The examples are included for explanatory purposes and is not limiting.

### Example 1—FIGS. 6A-6C

An example data storage device includes an object storage (600) as illustrate in FIG. 6A. The object storage (600) includes three segments: Segment A (601), Segment B (602), and Segment C (603). Each of the segments (601-603) are unique, i.e., are not duplicate of each other.

Due to a random error, an index of the data storage is corrupted and the data storage device initiates an index rebuild process. As part of the index rebuild process, the index (620) and index cache (640) shown in FIGS. 6B and 6C, respectively, are generated.

More specifically, as part of the rebuild process, the data storage device generates a fingerprint of each segment (601-603) of the object storage (600) while in an offline state. The data storage device then stores each of the fingerprints of the segments in the Index (620) and the index cache (640).

FIG. 6B shows a diagram of the rebuilt index (620). The rebuilt index (620) includes three entries (621, 624, 627). The entries include a respective fingerprint (622, 625, 628) and an identifier of the segment from which the respective fingerprint was generated.

FIG. 6C shows a diagram of the rebuilt index cache (640). The rebuilt index cache (640) includes the fingerprint (622, 625, 628) generated using each of the segments of the object storage, respectively.

### Example 2 FIGS. 7A-7C

A second example data storage device includes an object storage (700) as illustrate in FIG. 7A. The object storage (700) includes three segments: Segment A (701), Segment B (702), and Segment C (703). Segments A and B (701, 702) are unique, i.e., are not duplicate of each other. Segment C (703) is a duplicate of segment A (701).

Due to a random error, an index of the data storage is corrupted and the data storage device initiates an index rebuild process. As part of the index rebuild process, the index (720) and index cache (740) shown in FIGS. 7B and 7C, respectively, are generated.

More specifically, as part of the rebuild process, the data storage device generates a fingerprint of each segment (701-703) of the object storage (700) while in an offline state. The data storage device then stores each of the fingerprints of the segments in the index (720) and a portion of the fingerprints in the index cache (740).

FIG. 7B shows a diagram of the rebuilt index (720). The rebuilt index (720) includes three entries (721, 724, 727). The entries include a respective fingerprint (722, 725, 728) and an identifier of the segment from which the respective fingerprint was generated.

FIG. 7C shows a diagram of the rebuilt index cache (740). The rebuilt index cache (740) includes fingerprint A of segment A (741) and fingerprint B of segment B (742). A fingerprint of segment C (703, FIG. 7A) is not included because it was deleted, rather than stored, because it is a duplicate of fingerprint A of segment A (741).

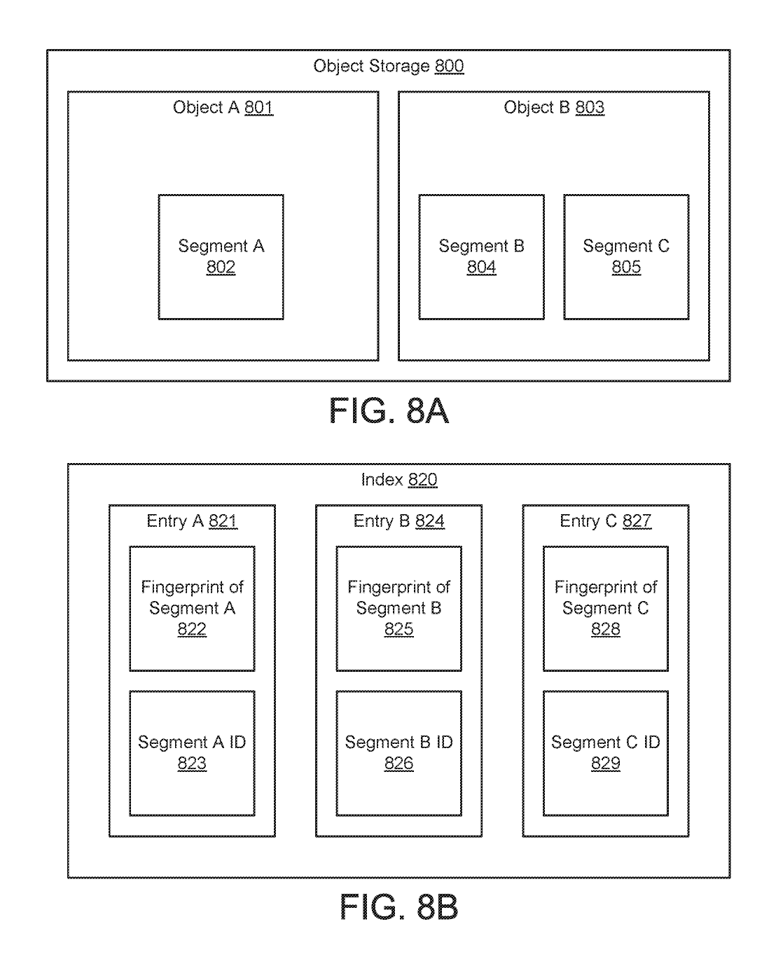

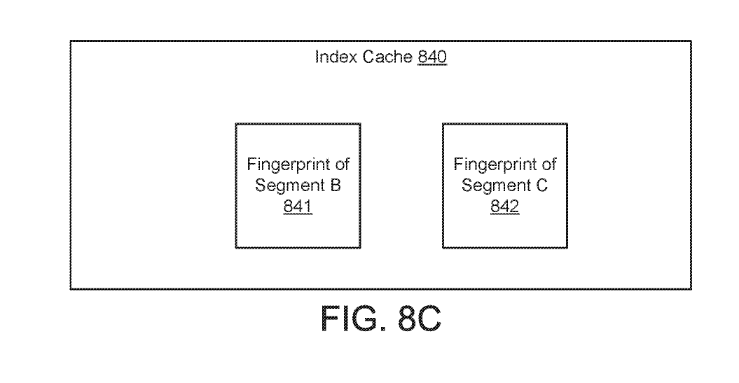

### Example 3—FIGS. 8A-8C

A third example data storage device includes an object storage (800) as illustrate in FIG. 8A. The object storage (700) includes two object: object A (801) and object B (803). Object B has a larger identifier than object A. Object A includes segment A (701) and object B (803) includes segment B (702) and segment C (703).

Due to a random error, an index of the data storage is corrupted and the data storage device initiates an index rebuild process. As part of the index rebuild process, the index (820) and index cache (840) shown in FIGS. 8B and 8C, respectively, are generated.

More specifically, as part of the rebuild process, the data storage device generates a fingerprint of each segment (802, 804, 805) of the object storage (800) while in an offline state. The data storage device then stores each of the fingerprints of the segments in the index (820) and a portion of the fingerprints in the index cache (840).

FIG. 8B shows a diagram of the rebuilt index (820). The rebuilt index (820) includes three entries (821, 824, 827). The entries include a respective fingerprint (822, 825, 828) and an identifier (823, 826, 829) of the segment from which the respective fingerprint was generated.

FIG. 8C shows a diagram of the rebuilt index cache (740). The rebuilt index cache (840) includes fingerprint of segment B (841) and fingerprint of segment B (842). A fingerprint of segment A (802, FIG. 8A) is not included because it was deleted, rather than stored, because segment A. (802, FIG. 8A) is stored in object A (801, FIG. 8A) which has an identifier that indicates the segments included in the object all have a storage age greater than a predetermined storage age.

One or more embodiments of the invention may be implemented using instructions executed by one or more processors in the data storage device. Further, such instructions may correspond to computer readable instructions that are stored on one or more non-transitory computer readable mediums.

One or more embodiments of the invention may enable one or more of the following: i) improved rate of deduplication of data following an index rebuild by populating/partially populating a cache, ii) reduced computational/TO bandwidth cost of performing deduplication using a cache by reducing the chance of cache miss following an index rebuild, and iii) improve a user experience of storing data in a data storage device by reducing the likelihood that storing data in the data storage device taking an unusually long amount of time due to cache misses.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A data storage device, comprising:
a cache for an object storage; and
a processor programmed to:
suspend processing of files for storage in the object storage,
while the processing of files is suspended:
generate a rebuilt index using the object storage,
generate a rebuilt index cache using the object storage,
store the rebuilt index in the object storage, and
store the rebuilt index cache in the cache.

2. The data storage device of claim 1, wherein the processor is further programmed to:
after storing the index cache in the cache, resume processing of files for storage in the object storage.

3. The data storage device of claim 1, wherein the cache is stored on at least one solid state drive.

4. The data storage device of claim 3, wherein the index is not stored on the at least one solid state drive.

5. The data storage device of claim 1, wherein the processing of files for storage in the object storage comprises:
deduplicating the files for storage in the object storage.

6. The data storage device of claim 5, wherein deduplicating the files for storage in the object storage comprises:
segmenting the files to obtain a plurality of segments;
matching a fingerprint of each segment of the plurality of segments to a second plurality of fingerprints stored in the index cache;
selecting a portion of the segments based on the match; and
deleting the portion of the segments without storing copies of the segments in the object storage.

7. The data storage device of claim 1, wherein the processor is further programmed to:
identify an index rebuild event,
wherein processing of the files for storage in the object storage is suspended in response to identifying the index rebuild event.

8. The data storage device of claim 7, wherein the index rebuild event is corruption of a fingerprint stored in an index of the object storage.

9. The data storage device of claim 1, wherein generating the rebuilt index using the object storage comprises:
storing a fingerprint of each segment in the object storage in the rebuilt index; and
storing a segment identifier of each segment in the object storage in the rebuilt index.

10. The data storage device of claim 9, wherein generating the rebuilt index cache using the object storage comprises:
storing the fingerprint of each segment in the object storage in the rebuilt index cache.

11. The data storage device of claim 9, wherein generating the rebuilt index using the object storage further comprises:
generating the fingerprint of each segment in the object storage before storing the fingerprint of each segment in the object storage in the rebuilt index.

12. The data storage device of claim 11, wherein generating the fingerprint of each segment in the object storage comprises:
generating a hash of each segment in the object storage, wherein the hash is generated using a cryptographic hash function.

13. The data storage device of claim 12, wherein the cryptographic hash function is Secure Hash Algorithm 1 (SHA-1).

14. The data storage device of claim 1; where generating a rebuilt index cache using the object storage comprises:
selecting a segment stored in the object storage;
generating a fingerprint of the selected segment;
making a determination that the generated fingerprint matches a second fingerprint in the index cache; and
deleting the generated fingerprint without storing the generated fingerprint in the index cache in response to the determination.

15. The data storage device of claim 1, where generating a rebuilt index cache using the object storage comprises:
selecting a segment stored in the object storage;
making a determination that the selected fingerprint has a storage age greater than a predetermined storage age; and
not storing a fingerprint of the selected fingerprint in the index cache in response to the determination.

16. A method of operating a data storage device, comprising:
suspending, by the data storage device, processing of files for storage in an object storage,
while the processing of files is suspended:
generating; by the data storage device, a rebuilt index using the object storage and a rebuilt index cache using the object storage,
storing, by the data storage device, the rebuilt index in the object storage, and
storing, by the data storage device, the rebuilt index cache in a cache for the object storage.

17. The method of claim 16, further comprising:
identify, by the data storage device, an index rebuild event,
wherein processing of the files for storage in the object storage is suspended in response to identifying the index rebuild event.

18. The method of claim 17, further comprising:
after storing the index cache in the cache, resuming, by the data storage device, processing of files for storage in the object storage.

19. The method of claim 16, wherein generating, by the data storage device, a rebuilt index using the object storage and a rebuilt index cache using the object storage comprises:
selecting a segment stored in the object storage;
generating a fingerprint of the selected segment; and
storing the generated fingerprint in the index and the index cache before generating a fingerprint of a second segment of the object storage.

20. A non-transitory computer readable medium comprising computer readable program code, which when executed by a computer processor enables the computer processor to perform a method for operating a data storage device, the method comprising:
suspending, by the data storage device, processing of files for storage in an object storage,
while the processing of files is suspended:
generating, by the data storage device, a rebuilt index using the object storage and a rebuilt index cache using the object storage,
storing, by the data storage device, the rebuilt index in the object storage, and
storing, by the data storage device, the rebuilt index cache in a cache for the object storage.
